(19) United States
(12) Patent Application Publication
(10) Pub. No.: US 2022/0358069 A1
(43) Pub. Date: Nov. 10, 2022

(54) ADVANCED CENTRALIZED CHRONOS NoC

(71) Applicant: CHRONOS TECH LLC, San Diego, CA (US)

(72) Inventors: Stefano GIACONI, San Diego, CA (US); Giacomo RINALDI, San Diego, CA (US); Matheus GIBILUKA, San Diego, CA (US)

(21) Appl. No.: 17/738,744

(22) Filed: May 6, 2022

Related U.S. Application Data
(60) Provisional application No. 63/185,605, filed on May 7, 2021.

(51) Int. Cl. G06F 13/40; G06F 13/38

(52) U.S. Cl. CPC G06F 13/4022; G06F 13/385; G06F 13/405; G06F 2213/3808; G06F 2213/0038

(57) ABSTRACT

System and methods for an Advance Centralized Chronos Network on Chip (ACC-NoC) design are disclosed. The ACC-NoC is able to efficiently satisfy interconnect traffic requirements of modern Systems of Chip and simplify top level timing closure while providing high throughput and low latency. The ACC-NoC in a System on Chip may include a centralized intelligent switch and arbitration engine communicatively coupled to different intellectual property (IP) blocks through series of one or more Chronos Channels which transmit data using delay insensitive (DI) codes and quasi-delay-insensitive (QDI) logic.

### RELATED APPLICATIONS INFORMATION

The present application claims the benefit of priority under 35 U.S.C. 119(e) to Provisional Patent Application Ser. No. 63/185,605, entitled “ADVANCED CENTRALIZED CHRONOS NoC”, filed on May 7, 2021, which is incorporated herein by reference as if set forth in full.

The present application is also related to U.S. application Ser. No. 15/344,416, filed on Nov. 4, 2016, which granted as U.S. Pat. No. 9,977,852 on May 22, 2018; U.S. application Ser. No. 15/344,420, filed on Nov. 4, 2016, which granted as U.S. Pat. No. 9,977,853 on May 22, 2018; U.S. application Ser. No. 15/344,441, filed on Nov. 4, 2016, which granted as U.S. Pat. No. 10,073,939 on Sep. 11, 2018; U.S. application Ser. No. 15/645,917, filed on Jul. 10, 2017, which granted as U.S. Pat. No. 10,181,939 on Jan. 15, 2019; U.S. application Ser. No. 15/644,696, filed on Jul. 7, 2017, which granted as U.S. Pat. No. 10,331,835 on Jun. 25, 2019; U.S. application Ser. No. 16/053,486, filed on Aug. 2, 2018, which granted as U.S. Pat. No. 10,637,592 on Apr. 28, 2020; U.S. application Ser. No. 16/266,994, filed on Feb. 4, 2019; and U.S. application Ser. No. 16/827,256, filed on Mar. 23, 2020, the disclosures of which are each incorporated by reference in their entirety as if set forth in full.

### BACKGROUND

### 1. Technical Field

The various embodiments described herein are related to application specific integrated circuits (ASICs), and more particularly to the design of various ASICs.

### 2. Related Art

Continuing advances in semiconductor device fabrication technology have yielded a steady decline in the size of process nodes. For example, 7 nanometer (nm) process nodes were introduced in 2017 but were quickly succeeded by 5 nm nm fin-field-effect-transistors (FinFETs) in 2018 while 3 nm gate-all-around-field-effect-transistors (GAAFETs) process nodes are projected for commercialization by end of 2021.

The decrease in process node size allows a growing number of intellectual property (IP) cores or IP blocks to be placed on a single ASIC chip. Latest ASIC designs often use a comparatively large silicon die and include combinations of independent IP blocks and logic functions. At the same time, modern applications also require increased connectivity and large data transfers between various IP blocks. The vast majority of modern ASIC chips are heterogenous systems to enable optimization of performance and power figures for the numerous IPs, as well as multi-core implementations, leading to a very complicated interconnect sub-system.

All indications point to an even higher levels of integration and data processing in further System on Chips (SoCs) in the year to come. This will allow even more functions to be added, making systems more complex, more intelligent, more power efficient while putting even more pressure on the interconnect fabric.

Interconnect fabrics have changed over time to address requirements of evolving systems. Traditional busses (such as AMBA AHB) have evolved over time, to more intelligent crossbars and later hierarchical crossbars which enabled faster data switching among multiple ports or port domains. Once the number of busses and data width grew to an unmanageable amount, the industry responded with more flexible packetized approach (as it was done previously for computer hardware networks) through the development of Network on Chips (NoCs).

NoCs have been able to handle bandwidth more efficiently by utilizing packetization and Quality of Service (QoS) channel prioritization strategies. NoC started as a centralized IP, more like a smarter crossbar with a certain number of input ports and output ports, regulated by specific routing rules. Once SoC size started to grow significantly, the distance between IPs became significant, at that time the centralized NoC slowly transformed into a distributed NoC, where individual routers were dispersed across the silicon area following a specific arrangement (such as ring, torus, mesh, etc.) and connected to each other to create a network.

Modern SoCs for Artificial Intelligence (AI) and Machine Learning (ML) requires high throughout and most importantly low latency architectures. Data must move between GPUs, TMUs or CPUs and the Memory system with minimum latency, because most of the operations use a very large amount of data and repeated linear matrices operations.

In a traditional Synchronous NoC the common way to minimize latency relies on running the system at the highest clock frequency possible. This approach generates two issues:
1. If the NoC uses a distributed architecture: it requires creating a very high-speed clock distribution network, which is a very difficult task do and analyze. Making timing closure at top level extremely challenging if not impossible (long data-paths imply larger on-chip variation and also larger clock jitter margin across process, voltage, temperature (PVT) variations as well as different modes of operation of the SoC.
2. If instead the NoC uses a centralized architecture: it becomes much easier to close timing within the NoC IP itself, even if using a very high-speed clock. (It can be designed very compact minimizing the clock distribution network). On the other hand, the challenge is traded to the high-speed pipelines connecting the centralized NoC to the different IP ports, really moving the problem around.

Therefore, what is needed are an apparatus and method that overcome these significant problems found in the aforementioned conventional approach to ASIC design, as well as a way of routing the information among the different IPs efficiently and with minimized latency.

### SUMMARY

Apparatuses and methods for ASIC design are provided.

In one embodiment, a centralized Network-on-Chip (NOC) system is disclosed. The NOC system comprises a plurality of intellectual property (IP) blocks; a centralized switch block; and communication channels coupled between the centralized switch block and one or more of the plurality of IP blocks, wherein each of the communication channels is configured (i) to transmit data between the centralized switch block and the one or more of the plurality of IP blocks and (ii) to encode the data using delay insensitive coding and transmit the encoded data using a quasi-delay insensitive logic and a clock-less temporal compression ratio.

In another embodiment, a System on Chip (SoC) using network-on-chip (NoC) sub-units is disclosed. The SoC comprises: a high speed (HS) switch block; a medium speed (MS) switch block; one or more fast IP blocks; one or more medium speed IP blocks; first communication channels coupled between the HS switch block and each of the one or more fast IP blocks; second communication channels coupled between the MS switch block and each of the one or more medium speed IP blocks; and a third communication channel coupled between the HS switch block and the MS switch block, wherein each of the first communication channels, the second communication channels, and the third communication channel is configured to encode data using delay insensitive coding and transmit the encoded data using a quasi-delay insensitive logic circuit and a clock-less temporal compression ratio.

Other features and advantages of the present inventive concept should be apparent from the following description which illustrates by way of example aspects of the present inventive concept.

### BRIEF DESCRIPTION OF THE DRAWINGS

The above and other aspects and features of the present inventive concept will be more apparent by describing example embodiments with reference to the accompanying drawings, in which:

FIG. 1 is a general block diagram illustrating a possible embodiment of a generic Chronos Channel implementation;

FIG. 2 is a general block diagram of a possible embodiment of a SoC where IPs are connected through an Advanced Centralized Chronos NoC (ACC-NoC); and

FIG. 3 is a general block diagram illustrating a possible embodiment of a SoC where IPs are connected through a hierarchical Advanced Centralized Chronos NoC (ACC-NoC).

### DETAILED DESCRIPTION

While certain embodiments are described, these embodiments are presented by way of example only, and are not intended to limit the scope of protection. The methods and systems described herein may be embodied in a variety of other forms. Furthermore, various omissions, substitutions, and changes in the form of the example methods and systems described herein may be made without departing from the scope of protection.

This invention describes an Advanced Centralized Chronos NoC which is able to efficiently satisfy the interconnect traffic requirement of modern SoC, simplifying top level timing closure while providing high throughput and low latency.

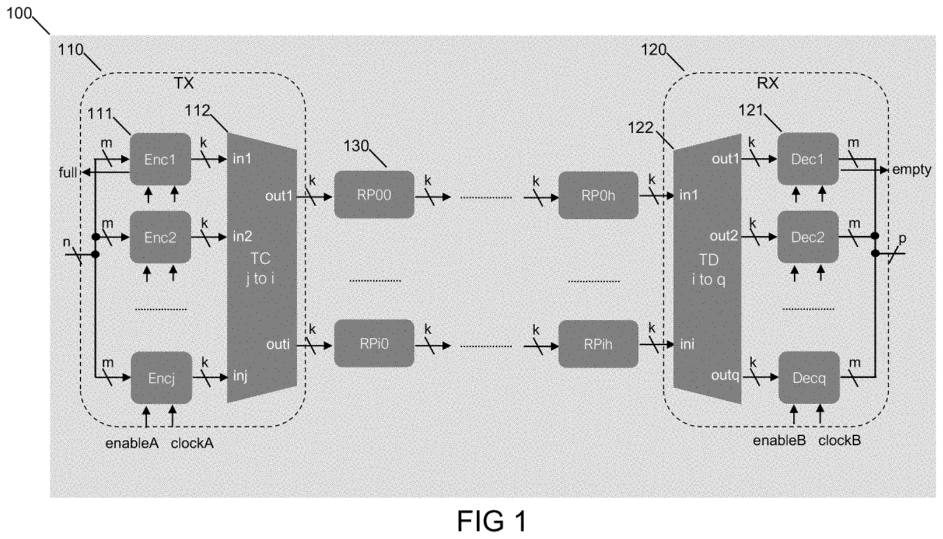

FIG. 1 shows a Chronos Channel, 100, which is an ASIC Interconnect that allows transmitter blocks to send data to receiver blocks. Chronos Channels stand out by relying on a reduced set of timing assumptions and being robust against delay variations. To do so, Chronos Channels transmit data using delay insensitive (DI) codes and quasi-delay-insensitive (QDI) logic. In this way, Chronos Channels are insensitive to all wire and gate delay variations, but for those belonging to a few specific forking logic paths called isochronic forks. Also, a unique characteristic of a Chronos Channel, when compared to related solutions, is that it uses temporal compression in its internal paths to reduce the overheads of QDI logic and efficiently transmit data. In fact, data can be compressed by different ratios, which can be any rational number (as long as a technology specific maximum frequency restriction is respected). In this way, a Chronos Channel is defined by the combination of a DI code (and related handshake protocol), a temporal compression ratio and the hardware required to encode, decode, encrypt, decrypt, compress, decompress and transmit data.

To implement a Chronos Channel in a target technology, different circuits can be employed. FIG. 1 shows a block diagram of a possible embodiment of a generic Chronos Channel implementation with the general hardware organization, in various embodiments, to explore the functionality of these circuits. In this hardware organization 100 there are 5 main components: encoders (Enc) 111; temporal compressors (TC) 112; repeaters (RP) 130; temporal decompressors (TD) 122; and decoders (Dec) 121.

An encoder 111 is responsible for transforming the input data (e.g., input data received from a producer IP block to be transmitted to a consumer IP block), which is represented using “m” wires, into encoded data that uses “k” wires and a specific DI code. A Chronos Channel requires “j” encoders 111, where “j” is the size of the input data divided by the size of the DI code of choice. Also, encoder blocks 111 may require input control signals to indicate the validity of the data in their inputs. A clock signal (clockA) can be used for synchronous data inputs and an enable signal (enableA) can be used to enable or disable data consumption in order to fulfil specific data transmission protocol requirements. These encoder blocks 111 also generate an output control signal to indicate when the Chronos Channel is full and cannot accept new data. Note that data in either the inputs or the outputs of an encoder 111 can be digital or analog.

The TC 112 splits a “j” sized set of encoded data in “j/i” (or the temporal compression ratio) “i” sized sets of encoded data. Then, the TC 112 issues each of the “j/i” sets in its outputs, one at a time. To control the flow of this data, the handshake protocol defined by the choice of DI code is used. Note that the maximum time to transmit each of the “j/i” sets is the delay of the slot defined by the target cycle time divided by the compression ratio. In this way, and assuming that the remaining parts of the circuit will also be able to consume the data while guaranteeing cycle time performance, all the “j/i” sets will be sent in one cycle time. The outputs of the TC 112 can feed either a repeater 130 or the TD 122 directly. Also, note that in case “j/i” is not a natural number, but rather a positive rational number, the TC 112 will use only the required number of its outputs in the transmission of the last slots of data. Nevertheless, the division of the cycle time in slots will still be a natural number defined as the ceiling function of “j/i”.

Repeaters 130 have memory elements and are capable of holding encoded data and sending it to a next repeater or the TD 122. To control the flow of this data, the handshake protocol defined by the choice of DI code is used. Furthermore, the maximum time to transmit each of the “j/i” sets is also the delay of the slot defined by the target cycle time divided by the compression ratio. Note that repeaters 130 may or may not be required in a Chronos Channel, as they are used to fix slot delay violations in long paths that fail to meet cycle time requirements or to improve signal strength. Also, note that different numbers of repeaters 130 may be required for the different outputs of a TC 112. This is valid because, in a Chronos Channel, there is no global control signal dictating how events flow through the data path. Rather, each path from an output of a TC 112 to the input of a TD 122 has an independent flow control. Again, the only restriction is the specified cycle time.

The TD 122 merges “q/i” sets of encoded data, each with size “i”, in a single set of encoded data with size “q”. Then the TD 122 issues the whole “q” sized set in its outputs, which feed the decoder blocks 121. To control the flow of this data, the handshake protocol defined by the choice of DI code is used. In this circuit, the maximum time to consume each of the “q/i” sets is the delay of the slot defined by the target cycle time divided by its compression ratio. Note that, in some embodiments, TDs 122 can have a different compression ratio than that of the TC 112 and can generate sets with a different size from those originally consumed by the TC 112. This is particularly useful when connecting transmitters and receivers with different clock frequencies. Also, if the compression ratio of the TD 122 is a positive rational number, it will only use the required number of its inputs in the consumption of the last slots of data.

The decoder 121 is responsible for transforming input encoded data, which is represented using “k” wires and a specific DI code, back to the original input data that used “m” wires. In various embodiments, the decoder 121 is configured to transform the input encoded data to form a representation of the data signals input to the encoders 111, the representation being compliant to an input data format of the consumer IP block. To decode data, a Chronos Channel needs “q” decoders, as defined in the compression ratio of the TD 133. A decoder block may also require input control signals to indicate that data in its outputs was successfully collected. To do so, a clock signal (clockB) can be used, for synchronous data outputs, and an enable signal (enableB) can be used to enable or disable the generation of new data in the outputs of the Chronos Channel, to fulfil specific data transmission protocol requirements. Furthermore, decoders 121 also generate an output control signal to indicate when they are empty, which means there is no data in the Chronos Channel to be consumed. Note that data in either the inputs or the outputs of a decoder 121 can be digital or analog.

Another important concept in a Chronos Channel is the definition of TX and RX blocks. As FIG. 1 shows, TX 110 is the block that comprises the encoders 111 and TC 112 of the channel and RX 120 is the block that comprises the decoders 121 and TD 122 of the channel. In this way, the control signals connected to the TX 110 (enableA, clockA and full) must be produced and consumed by the transmitter connected to the Chronos Channel, whenever applicable. This means that the clock connected to the TX 110 (clockA) must be the same clock connected to the transmitter, assuming that the transmitter is synchronous. The same is valid for the input and output control signals of the TX 110 (enableA and valid), they must be respectively produced and consumed by the transmitter. In a similar way, the control signals of the RX 120 (enableB, clockB and empty) must be produced and consumed by the receiver connected to the Chronos Channel.

Due to the asynchronous communication between TX and RX blocks 110 and 120, a Chronos Channel can interface transmitters and receivers that operate at different frequencies and with different data bus widths (as the compression ratios can be different in the TX and RX blocks 110 and 120). However, to avoid data loss, it must be ensured that the receiver consumes data as fast as the producer generates new data. To do so, the output throughput must be greater or equal to the input throughput. More specifically, recalling FIG. 1: FB*p≥FA*n, where FB is the frequency of clockB and FA is the frequency of clockA.

The usage of controllers coupled to the TX 110 and RX 120 can enable avoiding the requirement of constrained frequencies between transmitter and receiver blocks. Such controllers must be able to implement a communication protocol using the control signals provided by the TX and RX blocks 110 and 120. Note that these signals allow implementing a variety of communication protocols, such as (and not limited to) handshake- or credit-based protocols. The coupling of controllers to a Chronos Channel generates what is called a Chronos Link, and enables leveraging the full flexibility of Chronos Channels. This is because transmitters and receivers connected to Chronos Links can be completely asynchronous to each other and communication may be established by a handshake procedure without any need to perform complex timing closure. An example of such an implementation is given in U.S. Pat. No. 9,977,853, the disclosure of which is incorporated herein by reference in its entirety.

Further examples of the Chronos Chanel are described in U.S. Pat. Nos. 9,977,852 and 9,977,853, the disclosures of which are incorporated herein by reference in their entireties as if set forth in full.

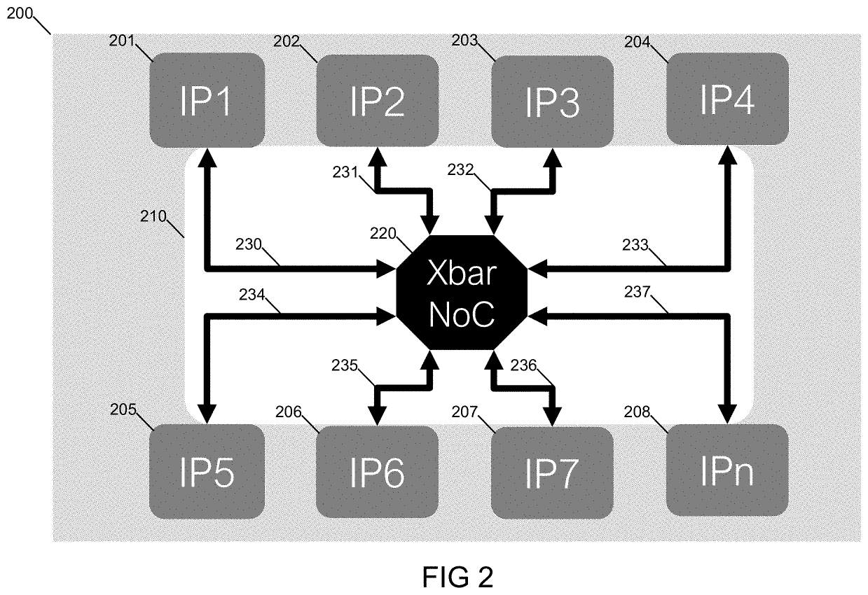

FIG. 2 shows a possible implementation of an Advanced Centralized Chronos NoC (ACC-NoC) 210. In this implementation different IPs 201-208 are connected to a centralized intelligent switch and arbitration engine 220, which can be a Crossbar, a NoC, or a similar device, through a series of one or more Channels 230-237. In various embodiments, each one of channels 230-237 may be implemented as Chronos Channel 100 of FIG. 1 and may be referred to as Chronos Channels 230-237.

The proposed architecture of the ACC-NoC in FIG. 2, enables to completely decouple the implementation of the switch and arbitration engine, from the channels connecting to the IP ports. Chronos Channels 230-237 are resilient to PVT, clockless and provide very low latency mitigating the difficult constraints of long synchronous pipelines, and allowing to centralize the switching element 220 to a compact location where (in a synchronous implementation) clocks can run at very high speed in order to maximize performance and minimize latency. This architecture eliminates the need of a distributed synchronous NoC where clock distribution and timing closure are the limiting factors. Chronos channels don't have a limitation in length and can operate at very small latency even for distant interconnects. The insensitivity to PVT makes them ideal also for crossing voltage domains. It is important to mention that in a Chronos channel the latency does not depend on the clock frequency, providing performance boost during low power modes.

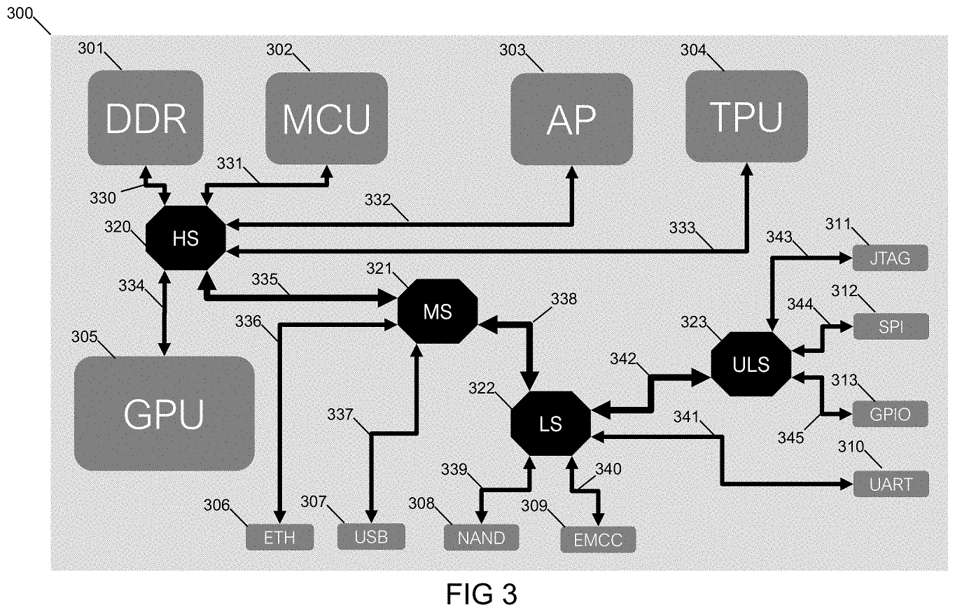

The architecture of FIG. 2 can be expanded to support switching hierarchy such as in FIG. 3. This example shows the implementation of a SoC 300 where the IPs are connected using a hierarchical ACC-NoC. Fast IPs such as double data rate (DDR) memory 301, microcontroller (MCU) 302, array processor (AP) 303, tensor processing unit (TPU) 304 and graphics processing unit (GPU) 305, are connected to a High-Speed (HS) switch and arbitration IP 320 though channels 330-334. The HS switch is also connected to a Medium Speed (MS) Switch and arbitration IP 321 through a channel 335. The MS switch connects to medium speed IPs 306-307 through channels 336-337, as well as to a Low Speed (LS) Switch and arbitration IP 322, still using a channel 338. The medium speed IPs may include, for example, an ethernet connection (ETH) 306 and a universal serial bus (USB) connection 307. The LS switch connects to three low speed IPs 308-310 through channels 339-341, and to a Ultra-Low-Speed (ULS) switch and arbitration IP 323 still using a channel 342. Finally, the ULS switch connect to three ultra-low-speed IPs 311-313 through the use of Chronos Channels 343-345. Each one of channels 330-345 may be implemented as Chronos Channel 100 of FIG. 1 and may be referred to as Chronos Channels 330-345.

The architecture of FIG. 3 expands the benefit discussed above by breaking down the global switching and routing structure into sub-units, allowing for clustered central IPs with appropriate performance and power figures. Each switching and routing unit can be a centralized Crossbar or a NoC and can be implemented either in a synchronous or asynchronous implementation. This architecture simplify deployment allowing each switching cluster to be centralized and optimized for the specific performance. Chronos channel take care of synchronizing and transporting data from the switching and routing units to the IPs with minimal latency without the need of a clock distribution.

What is claimed is:

1. A Network-on-Chip (NOC) comprising:
a switch and arbitration engine;
a plurality of intellectual property (IP) block interfaces;
communication channels communicatively coupled between the switch and arbitration engine and each of the plurality of IP block interfaces, wherein each of the communication channels is configured to encode data using delay insensitive coding and transmit the encoded data using a quasi-delay insensitive logic circuit and a clock-less temporal compression ratio.

2. The NOC of claim 1, wherein each of the communication channels is configured to serially distribute portions of the encoded data into a plurality of temporal slots based, in part, on the clock-less temporal compression ratio.

3. The NOC of claim 1, wherein the communication channels are configured to decouple a clock of the switch and arbitration engine from the plurality of IP block interfaces.

4. The NOC of claim 1, wherein the communication channels are configured to:
transmit data using an asynchronous signal and transform the asynchronous signal
into a synchronous domain at each of the plurality of IP block interfaces.

5. A Network-on-Chip (NOC) system comprising:
a plurality of intellectual property (IP) blocks;
a centralized switch block; and
communication channels coupled between the centralized switch block and one or more of the plurality of IP blocks, wherein each of the communication channels is configured (i) to transmit data between the centralized switch block and the one or more of the plurality of IP blocks and (ii) to encode the data using delay insensitive coding and transmit the encoded data using a quasi-delay insensitive logic and a clock-less temporal compression ratio.

6. The NOC system of claim 5, wherein the communication channels are configured to decouple a first clock of the centralized switch block from second clocks of the one or more of the plurality of IP blocks.

7. The NOC system of claim 5, wherein the centralized switch block comprises one of a crossbar and a network-on-chip.

8. The NOC system of claim 5, wherein each of the communication channels is insensitive to process, voltage, and temperature (PVT) variations.

9. The NOC system of claim 5, wherein the communication channels are configured to serially distribute portions of the encoded data into a plurality of temporal slots based, in part, on the clock-less temporal compression ratio and serially transmit the encoded data as temporally-compressed delay-insensitive asynchronous data.

10. The NOC system of claim 5, wherein the delay insensitive coding comprises analog signals.

11. The NOC system of claim 5, wherein a latency of each of the communication channels is independent of clock frequencies of the NOC system.

12. The NOC system of claim 5, wherein each of the communication channels is configured to translate a traditional handshake communication protocol into a compressed delay insensitive communication protocol wherein original control signals are not propagated to the communicative channel but embedded in the data itself.

13. A System on Chip (SoC) comprising:
a high speed (HS) switch block;
a medium speed (MS) switch block;
one or more fast IP blocks;
one or more medium speed IP blocks;
first communication channels coupled between the HS switch block and each of the one or more fast IP blocks;
second communication channels coupled between the MS switch block and each of the one or more medium speed IP blocks; and
a third communication channel coupled between the HS switch block and the MS switch block,
wherein each of the first communication channels, the second communication channels, and the third communication channel is configured to encode data using delay insensitive coding and transmit the encoded data using a quasi-delay insensitive logic circuit and a clock-less temporal compression ratio.

14. The SoC of claim 13, wherein a latency of each of the first communication channels, the second communication channels, and the third communication channel is independent of a clock frequency of the SoC.

15. The SoC of claim 13, wherein the one or more fast IP blocks comprises one or more of: a double data rate (DDR) block, a microcontroller unit (MCU), an array processor (AP), a tensor processing unit (TPU), and a graphics processing unit (GPU).

16. The SoC of claim 13, wherein the one or more medium speed IP blocks comprises one or more of: an ethernet and a universal serial bus block.

17. The SoC of claim 13, wherein each of the first communication channels, the second communication channels, and the third communication channel includes a first interface and a second interface, wherein a signal frequency at the first interface is decoupled from a signal frequency at the second interface.

18. The SoC of claim 13, wherein a latency of each of the first communication channels is independent of a clock frequency of the HS switch block.

19. The NOC system of claim 13, wherein each of the first communication channels, the second communication channels, and the third communication channel is configured to translate a traditional handshake communication protocol into a compressed delay insensitive communication protocol wherein original control signals are not propagated to the communicative channel but embedded in the data itself.

20. The NOC system of claim 13, wherein each of the first communication channels, the second communication channels, and the third communication channel is configured to serially distribute portions of the encoded data into a plurality of temporal slots based, in part, on the clock-less temporal compression ratio and serially transmit the encoded data as temporally-compressed delay-insensitive asynchronous data.
